(19) United States
(12) Patent Application Publication
(10) Pub. No.: US 2016/0253501 A1
(43) Pub. Date: Sep. 1, 2016

(54) Method for Detecting a Unified Extensible Firmware Interface Protocol Reload Attack and System Therefor

(71) Applicant: Dell Products, LP, Round Rock, TX (US)

(72) Inventor: Allen C. Wynn, Round Rock, TX (US)

(21) Appl. No.: 14/632,429

(22) Filed: Feb. 26, 2015

(51) Int. Cl. G06F 21/56; G06F 9/445

(52) U.S. Cl. CPC G06F 21/566; G06F 8/61; G06F 2221/034

(57) ABSTRACT

An installation notification routine is initialized at a driver, the routine maintaining a count of installation notifications corresponding to a first global unique identifier (GUID) received at the driver. The driver registers for protocol installation notification corresponding to the first GUID. Malicious activity is identified in response to receiving more than one installation notification at the installation notification routine.

### FIELD OF THE DISCLOSURE

This disclosure relates generally to information handling systems, and more particularly relates to detecting a Unified Extensible Firmware Interface protocol reload attack at an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. A unified extensible firmware interface (UEFI) can provide an interface between the hardware and firmware of the information handling system and an operating environment of the information handling system.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the present disclosure;

FIG. 2 is a phase diagram for a UEFI boot of the information handling system of FIG. 1;

FIG. 3 is a flow diagram illustrating a method according to a specific embodiment of the present disclosure;

FIG. 4 is a flow diagram illustrating a method according to another embodiment of the present disclosure;

FIG. 5 is a flow diagram illustrating a method according to yet another embodiment of the present disclosure; and

FIG. 6 is a flow diagram illustrating a method according to still another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

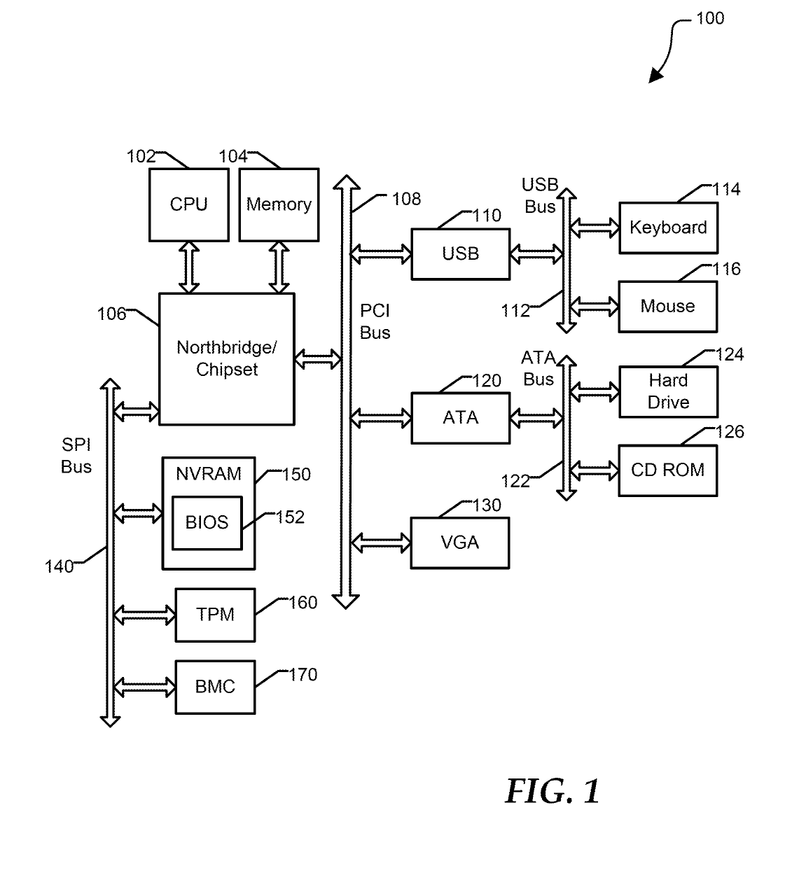

FIGS. 1-6 illustrate techniques for detecting malicious program activities. For example, a device driver can determine that a malicious program has attempted to reload a protocol that was previously installed by the device driver, or that a protocol associated with the driver has already been installed. In particular, a legitimate driver can register for notification when a protocol, with a corresponding GUID, is installed. The driver can maintain a record of how many times a notification has been received. For example, a single notification can correspond to installation of the protocol by the legitimate driver, while a subsequent notification can correspond to an attempt by a malicious program to alter an existing protocol.

FIG. 1 illustrates an information handling system 100 including a processor 102, a memory 104, a northbridge/chipset 106, a PCI bus 108, a universal serial bus (USB) controller 110, a USB 112, a keyboard device controller 114, a mouse device controller 116, an ATA bus controller 120, an ATA bus 122, a hard drive device controller 124, a compact disk read only memory (CD ROM) device controller 126, a video graphics array (VGA) device controller, a serial peripheral interface (SPI) bus 140, a non-volatile random access memory (NVRAM) 150 for storing a basic input/output system (BIOS) 152, a trusted platform module (TPM) 160, and a baseboard management controller (BMC) 170. Information handling system 100 can include additional components and additional busses, not shown for clarity. For example, system 100 can include multiple processor cores, one or more network interface controllers (NICs), and the like. While a particular arrangement of bus technologies and interconnections is illustrated for the purpose of example, one of skill will appreciate that the techniques disclosed herein are applicable to other system architectures. In one embodiment, portions of northbridge/chipset 106 can be integrated within CPU 102.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as CPU 102, a programmable logic array (PLA), an embedded device such as a System-on-a-Chip (SoC), or other control logic hardware. Information handling system 100 can also include one or more computer-readable medium for storing machine-executable code, such as software or data.

Additional components of information handling system 100 can include one or more storage devices that can store machine-executable code, one or more communications ports for communicating with external devices, and various input and output (I/O) devices, such as a keyboard, a mouse, and a video display. An example of information handling system 100 includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

BIOS 152 can be referred to as a firmware image, and the term BIOS is herein used interchangeably with the term firmware image, or simply firmware. BIOS 152 includes instructions executable by CPU 102 to initialize and test the hardware components of system 100, and to load a boot loader or an operating system (OS) from a mass storage device. BIOS 152 additionally provides an abstraction layer for the hardware, i.e. a consistent way for application programs and operating systems to interact with the keyboard, display, and other input/output devices. When power is first applied to information handling system 100, the system begins a sequence of initialization procedures. During the initialization sequence, also referred to as a boot sequence, components of system 100 are configured and enabled for operation, and device drivers can be installed. Device drivers provide an interface through which other components of the system 100 can communicate with a corresponding device.

In an embodiment, the BIOS 152 can be substantially compliant with one or more revisions of the UEFI specification. The UEFI standard replaces the antiquated personal computer BIOS system found in some older information handling systems. The UEFI specification provides standard interfaces and interoperability guidelines for devices that together make up an information handling system. In particular, the UEFI specification provides a standardized architecture and data structures to manage initialization and configuration of devices, booting of platform resources, and passing of control to the operating system. The UEFI specification allows for the extension of platform firmware by loading UEFI driver and UEFI application images. For example, an original equipment manufacturer can include customized or proprietary images to provide enhanced control and management of the information handling system 100. While the techniques disclosed herein are described in the context of a UEFI compliant system, one of skill will appreciate that the disclosed systems and methods can be implemented at substantially any information handling system having configurable firmware.

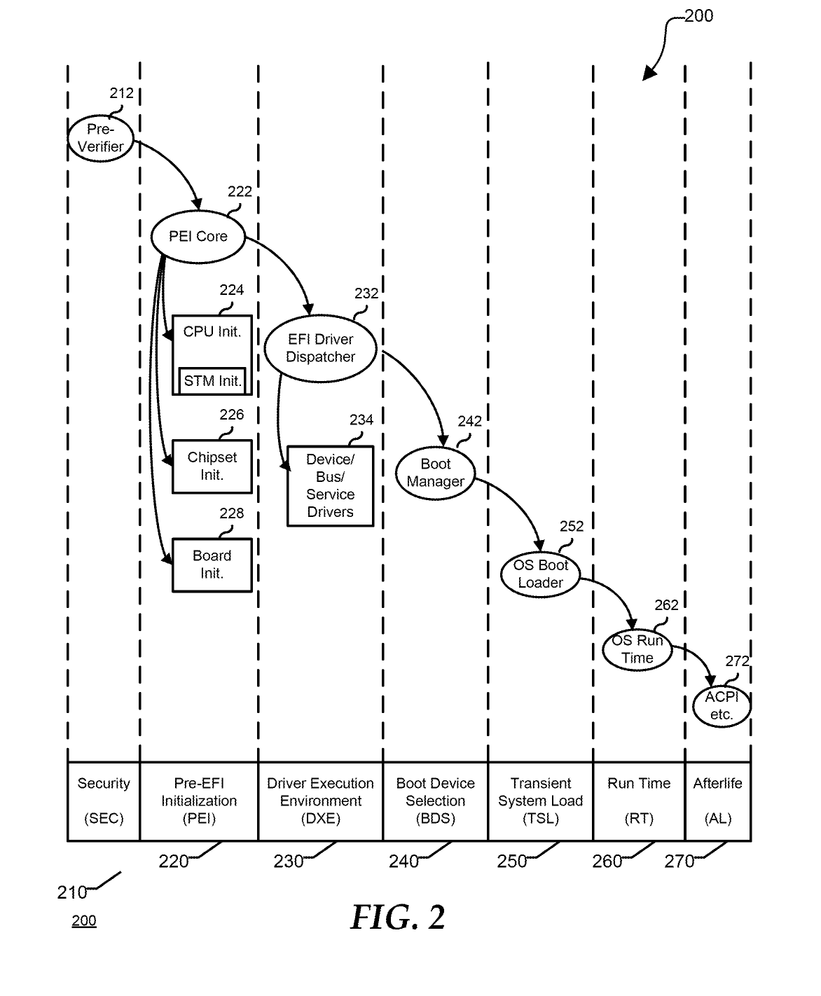

FIG. 2 illustrates a phase diagram 200 for an information handling system that operates using a UEFI, including a security phase (SEC) 210, a pre-EFI initialization phase (PEI) 220, a driver execution environment phase (DXE) 230, a boot device selection phase (BDS) 240, a transient system load phase (TSL) 250, a run time phase (RT) 260, and an afterlife phase (AL) 270. SEC 210 is the first phase of a UEFI boot process on the information handling system that operates to set up a pre-verifier 212. Pre-verifier 212 handles all restart events on the information handling system, and temporarily allocates a portion of memory for use during the other boot phases. SEC 220 is executed out of the firmware resident on the information handling system, such as BIOS 152, and so serves as a root of trust for the system. SEC 210 passes execution to PEI 220 which initializes the system memory for the information handling system. PEI 220 includes CPU initialization 224, chipset initialization 226, and board resource initialization 228.

PEI 220 passes execution to DXE 230 which performs device specific initializations for the information handling system. In particular, DXE 230 executes an EFI driver dispatcher 232 that operates to load device, bus, and service drivers 234. DXE 230 passes execution to BDS 240 executes a boot manager 242 which identifies a boot target, and passes execution to TSL 250. TSL 250 launches an OS boot loader 252 which loads the operating system, and passes execution to the operating system at RT 260. RT 260 can remain active until system 100 is reset, an Advanced Configuration and Power Interface (ACPI) event is initiated, and the like, at which time execution is passed to AL 270. AL 270 refers to times that the firmware takes control back from the OS, such as when system 100 enters a low-power mode of operation.

Techniques disclosed herein are typically implemented during DXE 230, and utilize services provided by the UEFI specification, such as boot services. UEFI applications, including OS loaders, must use boot services functions to access devices and allocate memory. Services are defined by interface functions that may be used by code running in the UEFI environment. Such code may include protocols that manage device access or extend platform capability, as well as applications running in the preboot environment, and OS loaders. During boot, system resources are owned by the firmware and are controlled through boot services interface functions. All boot services functionality is available until an OS loader loads enough of its own environment to take control of the system's continued operation and then terminates boot services with a call to ExitBootServices( ).

One class of boot services includes protocol handler services, such as LoadImage, StartImage, InstallProtocolInterface, RegisterProtocolNotify, LocateProtocol, and numerous others. A protocol consists of a 128-bit globally unique identifier (GUID) and a Protocol Interface structure. The structure contains the functions and instance data that are used to access a device. The functions that make up Protocol Handler Services allow applications to install a protocol on a handle, identify the handles that support a given protocol, determine whether a handle supports a given protocol, and the like. LoadImage loads an image, such as a device driver, into system memory, such as memory 104. StartImage transfers control to a loaded image's entry point. InstallProtocolInterface installs a protocol interface on a device handle. A driver can install multiple protocols. RegisterProtocolNotify registers an event that is to be signaled whenever an interface is installed for a specified protocol. LocateProtocol returns an array of handles that support a specified protocol. During DXE 230, boot services and runtime services can be started and a UEFI boot manager can load UEFI drivers and UEFI applications in an order defined by the global NVRAM variables. Driver initialization includes identifying a driver image that is stored on some type of media, such as at NVRAM 150. While the techniques disclosed herein are typically implemented during DXE 230, in another embodiment, these techniques can be implemented using UEIF system management services, such as SmmInstallProtocolInterface, SmmRegisterProtocolNotify, and the like.

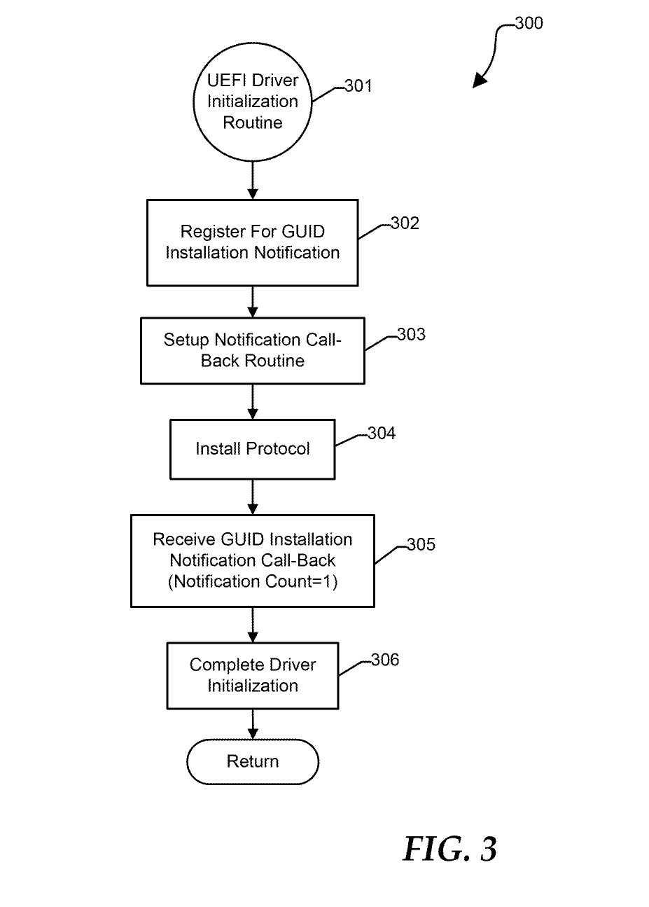

FIG. 3 is a flow diagram illustrating a method 300 according to a specific embodiment of the present disclosure. Method 300 is performed during a UEFI Driver Initialization routine 301. For example, a driver image can be loaded and started using the UEFI boot services LoadImage and StartImage. At block 302, a driver registers for GUID installation notification. For example, the driver can include one or more protocols that are to be installed during driver initialization. Each protocol is associated with a unique GUID identifying the protocol. The boot service RegisterProtocolNotify is invoked, identifying a particular protocol-GUID pair that is to be monitored. The RegisterProtocolNotify service will notify the driver that requested call-back if and when a protocol with the specified GUID is installed, such as by a malicious program. The method proceeds to block 303 where a notification call-back routine is initialized. The call-back routine is configured to maintain a count for a number of times that notification is received corresponding to each of one or more protocol GUIDs. The count is initialized to zero. The method continues at block 304 where one or more protocols are installed. For example, driver initialization can utilize the boot service InstallProtocolInterface to install a protocol. The method proceeds to block 305 where a GUID installation notification is received. In one scenario, the notification is a first notification, corresponding to the protocol installation performed at block 304. The notification call-back routine setup at block 303 increments the notification count. The notification count is now equal to one, indicating that a malicious program has not yet attempted to reload the protocol that is being monitored. The method continues at block 306 where driver initialization is completed.

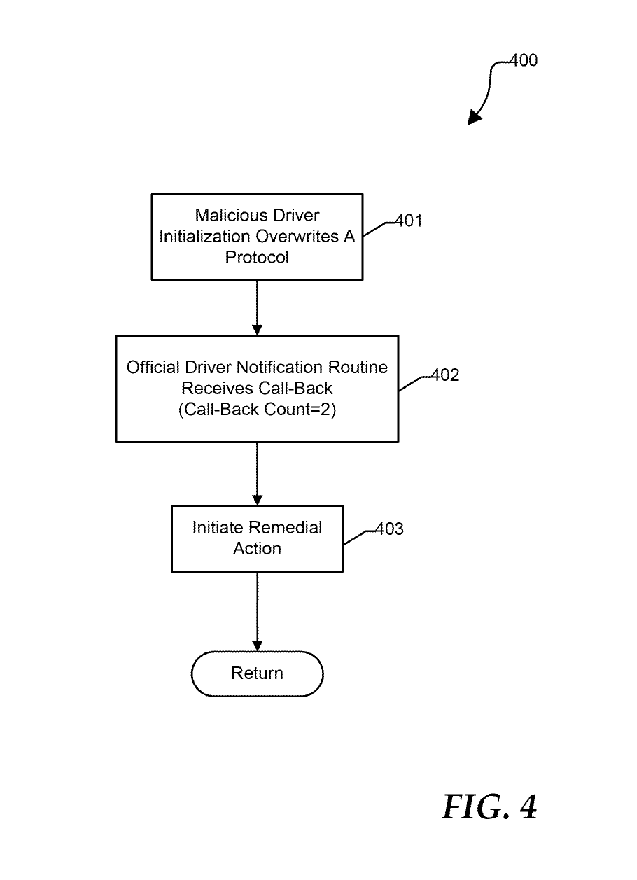

FIG. 4 is a flow diagram illustrating a method 400 according to another embodiment of the present disclosure. Method 400 begins at block 401 where a malicious driver overwrites a protocol that was previously installed by an official driver. For example, during initialization of a legitimate driver, such as described above with reference to method 300, a protocol can be installed. The protocol is identified by a unique GUID. At a later time, a malicious driver can invoke InstallProtocolInterface, specifying the same protocol GUID that is associated with the legitimate protocol. The method continues at block 402 where a GUID installation notification call-back is received at a notification routine established by an official driver. For example, at block 303 of method 300, an official driver registered for GUID notification in the event that a protocol associated with the official driver was installed.

As described above with reference to block 305, a count maintained by the notification call-back routine was previously equal to one, denoting the first protocol installation by the official driver. At block 402, notification is received at the official driver in response to the protocol reload by the malicious driver, and the call-back count maintained by the official driver is incremented to two. The method proceeds to block 403 where the notification routine at the official driver initiates remedial action in response to determining the call-back count is no longer equal to one. For example, the official driver can halt operation of system 100, attempt to reload the legitimate protocol, annotate a log file to indicating the malicious activity, transmit a warning message to an administrator, and the like.

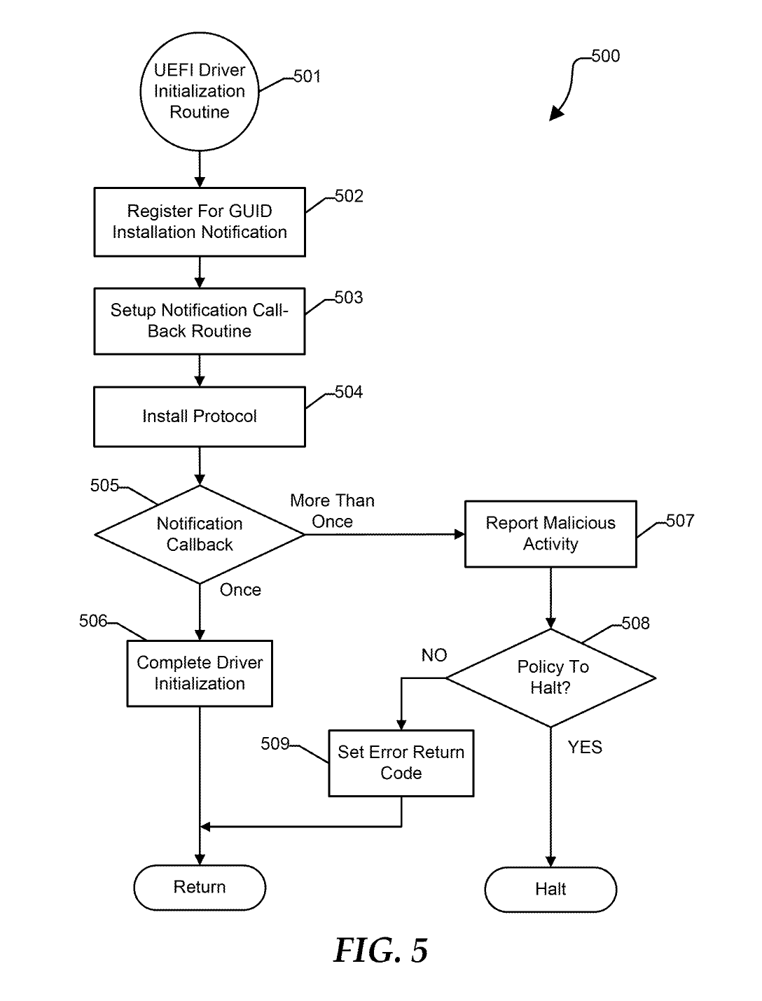

FIG. 5 is a flow diagram illustrating a method 500 according to yet another embodiment of the present disclosure. Method 500 is performed during a UEFI Driver Initialization routine 501. At block 502, a driver registers for GUID installation notification. For example, the driver can include one or more protocols that are to be installed during driver initialization. Each protocol is associated with a unique GUID identifying the protocol. The boot service RegisterProtocolNotify is invoked, identifying a particular protocol-GUID pair that is to be monitored. The method proceeds to block 503 where a notification call-back routine is initialized. The call-back routine is configured to maintain a count for a number of times that notification is received corresponding to each of one or more protocol GUIDs. The count is initially reset to a count of zero. The method continues at block 504 where one or more protocols are installed. For example, driver initialization can utilize the boot service InstallProtocolInterface to install a protocol.

The method continues at decision block 505, where the notification call-back routines determines whether a GUID installation notification call-back has been received more than once. If only one call-back has been received, the method proceeds to block 506 where driver initialization is completed, and the method is complete. If more than one call-back has been received, the method proceeds to block 507 where malicious activity can be reported. For example, the driver can receive a call-back corresponding to the original installation of the official protocol, bringing the call-back count maintained by the call-back routine to one. If a malicious driver reloads the protocol, an additional notification call-back will be received, incrementing the count to two. The driver can assume that this indicates malicious activity. The official driver can generate a message to notify an administrator that malicious activity was detected. One of skill will appreciate that the techniques disclosed herein provide for detection of malicious protocol activity independent of whether the malicious program is the first to install the particular protocol, or whether the malicious program attempts to reload the protocol after the official driver has installed the protocol.

The method continues at decision block 508 where it is determined whether a remedial policy is to halt operation at system 100. If the policy is to halt in response to the malicious activity, one or more operations at system 100 can be halted. If the policy does not specify halting in response to detecting a protocol reload, the method proceeds to block 509 where an error code is set. For example, a system log can be updated to register the protocol reload activity, and the driver initialization can terminate. Alternatively, an error policy can specify that the malicious activity is to be logged, but driver initialization can complete. In an embodiment, the driver can reload the protocol that is being monitored. In this scenario, a third notification call-back can be received, bringing the count to three. A subsequent call-back can indicate that malicious program has once again reloaded the protocol of interest.

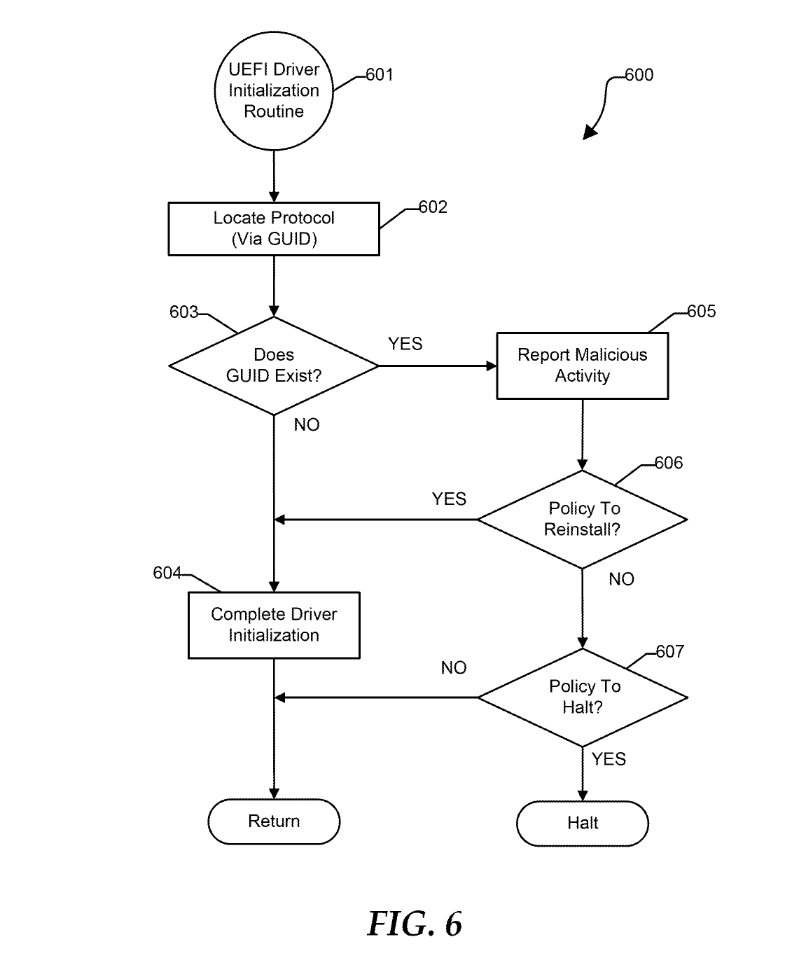

FIG. 6 is a flow diagram illustrating a method 600 according to still another embodiment of the present disclosure. Method 600 is performed during a UEFI Driver Initialization routine 601. At block 602, the driver issues a request to determine whether a protocol, identified by a GUID, has already been installed. For example, the UEFI boot service LocateProtocol can be utilized to make the inquiry. If a protocol with the identified GUID is found, LocateProtocol returns an array of handles that support the specified protocol. In an embodiment, an official driver can consider that any prior installation of a dependent protocol indicates malicious activity. If the protocol has not been previously installed, the method proceeds from decision block 603 to block 604 where driver initialization is completed. If, however, a protocol with the identified GUID has already been installed, the method proceeds from decision block 603 to block 605 where the malicious activity is reported. For example, the driver can generate a message to notify an administrator that malicious activity was detected, record an error message at a log file, and the like.

The method proceeds to decision block 606 where it is determined whether a remedial policy is to reinstall the protocol. If the policy is to reload the protocol, the method proceeds to block 604, where driver initialization is completed, including installation of the identified protocol. However, if the policy is not to reinstall the protocol, the method proceeds to decision block 607, where it is determined if a remedial policy is to halt in response to the malicious activity, one or more operations at system 100 can be halted. If the policy does not specify halting, initialization of the present driver can be terminated, and the boot process can continue. One of skill will appreciate that the features of method 600 can be incorporated into method 500. For example, a driver can identify whether a GUID-protocol pair has already been installed, and further provide the notification call-back routine of method 500.

Referring back to FIG. 1, the information handling system 100 can include a set of instructions that can be executed to cause the information handling system to perform any one or more of the methods or computer based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 can include a disk drive unit and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at system 100, and/or within the processor 102 during execution by the information handling system 100. The system memory 104 and the processor 102 also may include computer-readable media. A network interface device (not shown at FIG. 1) can provide connectivity to a network, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
initializing an installation notification routine at a driver at a data processing device, the routine maintaining a count of installation notifications corresponding to a first global unique identifier (GUID) received at the driver;
registering for protocol installation notification during initialization of the driver, the protocol corresponding to the first GUID; and
identifying malicious activity in response to receiving more than one installation notification at the installation notification routine.

2. The method of claim 1, further comprising installing a protocol corresponding to the first GUID.

3. The method of claim 2, further comprising reloading the protocol in response to the identifying.

4. The method of claim 2, further comprising receiving a first installation notification in response to installing the protocol.

5. The method of claim 2, further comprising receiving a second installation notification in response to installing the protocol.

6. The method of claim 1, wherein initializing the installation notification routine further comprises initializing the count to zero, and incrementing the count in response to receiving each protocol installation notification corresponding to the first GUID.

7. The method of claim 1, further comprising generating an inquiry to determine whether a protocol associated with the first GUID is installed.

8. The method of claim 1, further comprising halting a boot sequence at an information handling system in response to the identifying.

9. An information handling system comprising:
a processor; and
a memory device for storing instructions, the instructions to:
initialize an installation notification routine at a driver, the routine maintaining a count of installation notifications corresponding to a first global unique identifier (GUID) received at the driver;
register for protocol installation notification during initialization of the driver, the protocol corresponding to the first GUID; and
identify malicious activity in response to receiving more than one installation notification at the installation notification routine.

10. The system of claim 9, further comprising instructions to install a protocol corresponding to the first GUID.

11. The system of claim 10, further comprising instructions to reload the protocol in response to the identifying.

12. The system of claim 10, further comprising instructions to receive a first installation notification in response to installing the protocol.

13. The system of claim 10, further comprising instructions to receive a second installation notification in response to installing the protocol.

14. The system of claim 9, wherein initializing the installation notification routine further comprises initializing the count to zero, and incrementing the count in response to receiving each protocol installation notification corresponding to the first GUID.

15. The system of claim 9, further comprising instructions to generate an inquiry to determine whether a protocol associated with the first GUID is installed.

16. The system of claim 9, further comprising instructions to halt a boot sequence at the information handling system in response to the identifying.

17. A non-transitory data storage medium storing instructions executable by a processor to cause the processor to:
initialize an installation notification routine at a driver, the routine maintaining a count of installation notifications corresponding to a first global unique identifier (GUID) received at the driver;
register for protocol installation notification during initialization of the driver, the protocol corresponding to the first GUID; and
identify malicious activity in response to receiving more than one installation notification at the installation notification routine.

18. The storage medium of claim 17, further comprising instructions to install a protocol corresponding to the first GUID.

19. The storage medium of claim 18, further comprising instructions to receive a first installation notification in response to installing the protocol.

20. The storage medium of claim 17, further comprising instructions to halt a boot sequence at the information handling system in response to the identifying.
